(19) United States
(12) Patent Application Publication
(10) Pub. No.: US 2024/0287345 A1
(43) Pub. Date: Aug. 29, 2024

(54) POLYPROPYLENE RANDOM COPOLYMER FOR THREE-DIMENSIONAL PRINTING AND FILAMENT MADE THEREFROM

(71) Applicant: W.R. Grace & Co.-Conn., Columbia, MD (US)

(72) Inventors: Lian Bai, Laurel, MD (US); Xiaohui Liu, Highland, MD (US); Zhiru Ma, Ellicott City, MD (US)

(73) Assignee: W.R. Grace & Co.-Conn., Columbia, MD (US)

(21) Appl. No.: 18/568,565

(22) PCT Filed: Jun. 9, 2022
(86) PCT No.: PCT/US2022/032889

§ 371 Date: Dec. 8, 2023

Related U.S. Application Data
(60) Provisional application No. 63/209,147, filed on Jun. 10, 2021.

(51) Int. Cl. C09D 123/14; B33Y 70/00; C08F 210/06; C08K 3/26; C08K 3/34; C08K 7/14

(52) U.S. Cl. CPC C09D 123/14; B33Y 70/00; C08F 210/06; C08K 2003/265; C08K 3/34; C08K 7/14

(57) ABSTRACT

A polymer composition containing a polypropylene polymer having low shrinkage characteristics is disclosed. The polymer composition is particularly well suited for use in three-dimensional printing systems. For example, a polymer composition can be formulated containing the polypropylene polymer and formed into a filament, a rod or pellets that are then fed through a three-dimensional printer. The polypropylene polymer can be a random polypropylene copolymer or terpolymer that has controlled amounts of comonomer content and a xylene soluble content.

### CROSS-REFERENCE TO RELATED APPLICATIONS

This application claims the benefit of and priority to U.S. Provisional Appl. No. 63/209,147 filed Jun. 10, 2021, the contents of which are incorporated herein by reference in their entirety for any and all purposes.

### BACKGROUND

One type of additive manufacturing is referred to as three-dimensional printing. During three-dimensional printing, a part is formed or built in a layer-by-layer fashion to create a three-dimensional object from a digital model. Through three-dimensional printing, parts with complex shapes can be designed and created quickly and in an economical manner. For example, three-dimensional printing can be used to quickly produce prototypes that can be tested. As the technology has progressed, three-dimensional printing can also be used to mass produce parts and articles in all different industries and fields.

In one type of three-dimensional printing, a polymer filament is fed to a heated nozzle, which deposits a molten thermoplastic material onto a deposition surface. The molten thermoplastic material is applied one layer at a time until a three-dimensional, printed article is formed. In order to produce a three-dimensional article having a particular shape, the nozzle, the deposition surface, or both are moved while the molten thermoplastic polymer is being extruded through the nozzle. Movement of the different components can be controlled by a computer using a computer-aided design.

Thermoplastic polymers used in three-dimensional printing, for instance, should be capable of thermally bonding together when applied in layers in order to form a consolidated article. In addition, the thermoplastic polymer should have low shrinkage properties. If the polymer has a tendency to shrink during the process and after the part is formed, warping can occur which causes the corners of the printed part to lift and deform. For instance, thermoplastic polymers have a tendency to expand when heated and then shrink as they cool down and solidify. If the thermoplastic polymer shrinks too much, the different layers of the printed article can detach resulting not only in significant warpage but also a defective part. Polymer shrinking can also be a problem in the filaments that are used to produce the printed articles. For example, thermoplastic polymer filaments can undergo bulk shrinkage during printing which can also cause defects in the top layers of the resulting articles. These defects are due to the shrinkage of print filaments having higher molecular weights and higher elasticity.

Thermoplastic polymers that have been used in the past in three-dimensional printing include polylactic acid and acrylonitrile butadiene styrene (ABS). Polylactic acid and ABS generally display shrinkage characteristics of not greater than about 1%. Polylactic acid and ABS, however, display less than desirable interlayer adhesion. ABS polymers can also produce VOCs during the three-dimensional printing process. Polylactic acid, on the other hand, is hydrophilic which can cause problems during printing. Thus, polylactic acid filaments typically need to be stored in sealed packages to avoid humidity prior to the printing process.

Even though polylactic acid and ABS have various drawbacks, some thermoplastics polymers, such as polypropylene polymers, have been used sparingly in three-dimensional printing processes due to shrinkage and warpage issues. Polypropylene polymers, however, possess excellent physical properties that make the polymers well suited for use in producing molded articles. Thus, in view of the above, a need exists for a polymer composition containing a polypropylene polymer that can be used in three-dimensional printing processes.

### SUMMARY

In general, the present disclosure is directed to a polymer composition containing a polypropylene polymer that is well suited for use in a material extrusion process for producing three-dimensional articles. The present disclosure is also directed to a polymer material for a three-dimensional extrusion printing system. In accordance with the present disclosure, the polymer composition containing the polypropylene polymer is formulated to display low shrinkage and warpage characteristics.

In one embodiment, for instance, the present disclosure is directed to a polymer material for a three-dimensional extrusion printing system. The polymer material is in the form of a feed stock having a size and shape suitable to being fed to a three-dimensional printing system. The feed stock may comprise a continuous filament. When in the form of a filament, the filament can have a filament diameter of from about 0.5 mm to about 6 mm, such as from about 1.0 mm to about 4 mm. Alternatively, the feed stock may comprise polymer pellets or a polymer rod. In accordance with the present disclosure, the feed stock is comprised of a polymer composition containing a polypropylene polymer in an amount greater than about 50% by weight. For instance, the polymer composition can contain the polypropylene polymer in an amount greater than about 60% by weight, such as in an amount greater than about 70% by weight, such as in an amount greater than about 80% by weight, such as in an amount greater than about 90% by weight.

The polypropylene polymer contained in the polymer material is particularly constructed for use in three-dimensional printing processes. The polypropylene polymer, for instance, comprises a polypropylene random copolymer or terpolymer. More particularly, the polypropylene polymer includes propylene as a primary monomer and contains at least one comonomer of ethylene or butene. The total comonomer content of the polypropylene polymer is from about 3% to about 25% by weight. For example, the polypropylene polymer can have an ethylene content of from 0% to about 10% by weight and can have a butene content of from 0% to about 20% by weight. The polypropylene polymer can have a xylene soluble content of from about 4.5% to about 45% by weight, such as from about 5% to about 30% by weight, such as from about 10% to about 30% by weight. In one aspect, the xylene soluble content can be greater than about 12%, such as greater than about 18%, such as greater than about 20%. The polypropylene polymer can have a melt flow rate of from about 20 g/10 min to about 200 g/10 min, such as from about 20 g/10 min to about 100 g/10 min.

In one embodiment, the polypropylene polymer comprises a propylene and ethylene copolymer. The copolymer can have an ethylene content of from about 3% by weight to about 10% by weight, such as from about 5% by weight to about 9% by weight. Alternatively, the polypropylene polymer can comprise a propylene and butene copolymer. The propylene and butene random copolymer can have a butene content of from about 5% by weight to about 20% by weight, such as from about 10% by weight to about 18% by weight. In still another embodiment, the polypropylene polymer can comprise a propylene, ethylene, and butene terpolymer.

The polypropylene polymer can have a crystallinity of less than about 50%, such as less than about 40%. The polypropylene polymer can have a molecular weight distribution (Mw/Mn) of from about 2.5 to about 10, such as from about 3 to about 6. The polypropylene polymer can be Ziegler-Natta catalyzed using, for example, a non-phthalate catalyst. The catalyst, for instance, can include a substituted phenylene diester.

In one aspect, the polymer material can contain one or more fillers in addition to the polypropylene polymer. The filler, for instance, can be talc, calcium carbonate, glass fibers, or mixtures thereof. The filler can be present in the polymer composition in an amount from about 0% by weight to about 40% by weight.

The present disclosure is also directed to a printer cartridge for three-dimensional extrusion printing. The printer cartridge contains a feed stock made from the polymer material as described above. When in the form of a filament, for instance, the polymer material can be contained in the printer cartridge wound around a spool.

The present disclosure is also directed to a three-dimensional printing system comprising a three-dimensional printing device and a printer cartridge as described above. The present disclosure is also directed to a three-dimensional article formed layer by layer in a material extrusion process. The present disclosure is also directed to a material extrusion method comprising selectively forming a three-dimensional structure from the polymer material as described above.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a plan view of one embodiment of a material extrusion system that may be used in accordance with the present disclosure;

FIG. 2 is a perspective view of one embodiment of a printer cartridge that may be used in accordance with the present disclosure.

FIG. 3 is a perspective view with dimensions of models used for warpage testing described in the examples below; and

FIG. 4 is a perspective view with dimensions of another model used for warpage testing described in the examples below.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term—for example, “about 10 wt. %” would be understood to mean “9 wt. % to 11 wt. %.” It is to be understood that when “about” precedes a term, the term is to be construed as disclosing “about” the term as well as the term without modification by “about”—for example, “about 10 wt. %” discloses “9 wt. % to 11 wt. %” as well as disclosing “10 wt. %.”

The phrase “and/or” as used in the present disclosure will be understood to mean any one of the recited members individually or a combination of any two or more thereof—for example, “A, B, and/or C” would mean “A, B, C, A and B, A and C, B and C, or the combination of A, B, and C.”

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 atoms refers to groups having 1, 2, or 3 atoms. Similarly, a group having 1-5 atoms refers to groups having 1, 2, 3, 4, or 5 atoms, and so forth.

The term “propylene-ethylene copolymer”, as used herein, is a copolymer containing a majority weight percent propylene monomer with ethylene monomer as a secondary constituent. A “propylene-ethylene copolymer” (also sometimes referred to as a polypropylene random copolymer, PPR, PP-R, RCP or RACO) is a polymer having individual repeating units of the ethylene monomer present in a random or statistical distribution in the polymer chain.

The term “propylene-butene copolymer”, as used herein, is a copolymer containing a majority weight percent propylene monomer with butene monomer as a secondary constituent. A “propylene-butene copolymer” (also sometimes referred to as a polypropylene-butene random copolymer, is a polymer having individual repeating units of the butene monomer present in a random or statistical distribution in the polymer chain.

Melt flow rate (MFR), as used herein, is measured in accordance with the ASTM D1238 test method at 230° C. with a 2.16 kg weight for propylene-based polymers.

Xylene solubles (XS) is defined as the weight percent of resin that remains in solution after a sample of polypropylene random copolymer resin is dissolved in hot xylene and the solution is allowed to cool to 25° C. This is also referred to as the gravimetric XS method according to ASTM D5492-06 using a 90 minute precipitation time and is also referred to herein as the “wet method”. XS can also be measured according to the Viscotek Flow Injection Polymer Analysis (FIPA) method, as follows: 0.4 g of polymer is dissolved in 20 ml of xylenes with stirring at 130° C. for 60 minutes. The solution is then cooled to 25° C. and after 60 minutes the insoluble polymer fraction is filtered off. The resulting filtrate is analyzed by Flow Injection Polymer Analysis using a Viscotek ViscoGEL H-100-3078 column with THF mobile phase flowing at 1.0 ml/min. The column is coupled to a Viscotek Model 302 Triple Detector Array, with light scattering, viscometer and refractometer detectors operating at 45° C. Instrument calibration is maintained with Viscotek PolyCAL™ polystyrene standards. A polypropylene (PP) homopolymer, such as biaxially oriented polypropylene (BOPP) grade Dow 5D98, is used as a reference material to ensure that the Viscotek instrument and sample preparation procedures provide consistent results by using 5D98 as a control to check method performance. The value for 5D98 is initially derived from testing using the ASTM method identified above.

The ASTM D5492-06 method mentioned above may be adapted to determine the xylene soluble portion. In general, the procedure consists of weighing 2 g of sample and dissolving the sample in 200 ml o-xylene in a 400 ml flask with 24140 joint. The flask is connected to a water cooled condenser and the contents are stirred and heated to reflux under nitrogen (N₂), and then maintained at reflux for an additional 30 minutes. The solution is then cooled in a temperature controlled water bath at 25° C. for 90 minutes to allow the crystallization of the xylene insoluble fraction. Once the solution is cooled and the insoluble fraction precipitates from the solution, the separation of the xylene soluble portion (XS) from the xylene insoluble portion (XI) is achieved by filtering through 25 micron filter paper. One hundred ml of the filtrate is collected into a pre-weighed aluminum pan, and the o-xylene is evaporated from this 100 ml of filtrate under a nitrogen stream. Once the solvent is evaporated, the pan and contents are placed in a 100° C. vacuum oven for 30 minutes or until dry. The pan is then allowed to cool to room temperature and weighed. The xylene soluble portion is calculated as XS (wt %)=[(m₃−m₂)*2/m₁]*100, where m₁ is the original weight of the sample used, m₂ is the weight of empty aluminum pan, and m₃ is the weight of the pan and residue (the asterisk, *, here and elsewhere in the disclosure indicates that the identified terms or values are multiplied).

Ethylene or butene content is measured using a Fourier Transform Infrared method (FTIR) which is correlated to ethylene or butene values determined using ¹³C NMR as the primary method. The sequence distribution of monomers in the polymer may be determined by ¹³C-NMR, which can also locate butene residues in relation to the neighboring propylene residues. ¹³C NMR can be used to measure ethylene content, butene content, triad distribution, and triad tacticity, and is performed as follows:
The samples are prepared by adding approximately 2.7 g of a 50/50 mixture of tetrachloroethane-d2/orthodichlorobenzene containing 0.025 M Cr(AcAc)3 to 0.20 g sample in a Norell 1001-7 10 mm NMR tube. The samples are dissolved and homogenized by heating the tube and its contents to 150° C. using a heating block. Each sample is visually inspected to ensure homogeneity.
The data are collected using a Bruker 400 MHz spectrometer equipped with a Bruker Dual DUL high-temperature CryoProbe. The data are acquired using 512 transients per data file, a 6 sec pulse repetition delay, 90 degree flip angles, and inverse gated decoupling with a sample temperature of 120° C. All measurements are made on non-spinning samples in locked mode. Samples are allowed to thermally equilibrate for 10 minutes prior to data acquisition. Percent mm tacticity and weight % butene are calculated according to methods commonly used in the art, which is briefly summarized as follows.
With respect to measuring the chemical shifts of the resonances, the methyl group of the third unit in a sequence of 5 contiguous propylene units consisting of head-to-tail bonds and having the same relative chirality is set to 21.83 ppm. The chemical shift of other carbon resonances are determined by using the above-mentioned value as a reference. The spectrum relating to the methyl carbon region (17.0-23 ppm) can be classified into the first region (21.1-21.9 ppm), the second region (20.4-21.0 ppm), the third region (19.5-20.4 ppm) and the fourth region (17.0-17.5 ppm). Each peak in the spectrum is assigned with reference to a literature source such as the articles in, for example, Polymer, T. Tsutsui et al., Vol. 30, Issue 7, (1989) 1350-1356 and/or Macromolecules, H. N. Cheng, 17 (1984) 1950-1955, the contents of which are incorporated herein by reference.
   For convenience, butene content is also measured using a Fourier Transform Infrared method (FTIR) which is correlated to butene values determined using ¹³C NMR, noted above, as the primary method. The relationship and agreement between measurements conducted using the two methods is described in, e.g. J, R. Paxson, J. C. Randall, “Quantitative Measurement of Ethylene Incorporation into Propylene Copolymers by Carbon-13 Nuclear Magnetic Resonance and Infrared Spectroscopy”, Analytical Chemistry, Vol. 50, No. 13, November 1978, 1777-1780.

Mw/Mn (also referred to as “MWD”) and Mz/Mw are measured by GPC according to the Gel Permeation Chromatography (GPC) Analytical Method for Polypropylene. The polymers are analyzed on Polymer Char High Temperature GPC with IR5 MCT (Mercury Cadmium Telluride-high sensitivity, thermoelectrically cooled IR detector), Polymer Char four capillary viscometer, a Wyatt 8 angle MALLS and three Agilent Pigel Olexis (13 um). The oven temperature is set at 150° C. The solvent is nitrogen purged 1,2,4-trichlorobenzene (TCB) containing ˜200 ppm 2,6-di-t-butyl-4-methylphenol (BHT). The flow rate is 1.0 mL/min and the injection volume is 200 μl. A 2 mg/mL sample concentration is prepared by dissolving the sample in N2 purged and preheated TCB (containing 200 ppm BHT) for 2 hrs at 160° C. with gentle agitation. For the purposes of data processing, integration limits are set at points corresponding to 3500 g/mol at low molecular weight and where the signal intensity meets the baseline at high molecular weight.

The GPC column set is calibrated by running twenty narrow molecular weight distribution polystyrene standards. The molecular weight (MW) of the standards ranges from 266 to 12,000,000 g/mol, and the standards were contained in 6 “cocktail” mixtures. Each standard mixture has at least a decade of separation between individual molecular weights. The polystyrene standards are prepared at 0.005 g in 20 mL of solvent for molecular weights equal to or greater than 1,000,000 g/mol and 0.001 g in 20 mL of solvent for molecular weights less than 1,000,000 g/mol. The polystyrene standards are dissolved at 160° C. for 60 min under stirring. The narrow standards mixtures are run first and in order of decreasing highest molecular weight component to minimize degradation effect. A logarithmic molecular weight calibration is generated using a fourth-order polynomial fit as a function of elution volume. The equivalent polypropylene molecular weights are calculated by using following equation with reported Mark-Houwink coefficients for polypropylene (Th G. Scholte, N. L. J. Meijerink, H. M. Schoffeleers, and A. M. G. Brands, J. Appl. Polym. Sci. 29, 3763-3782 (1984)) and polystyrene(E. P. Otocka, R J. Roe, N. Y. Hellman, P. M. Muglia, Macromolecules, 4, 507 (1971)):

$${M}_{PP} = {( \frac{{K}_{PS} {M}_{PS}^{{a}_{PS} + 1}}{{K}_{PP}} )}^{\frac{1}{app + 1}}$$

where Mₚₚ is PP equivalent MW, M_{PS} is PS equivalent MW, log K and a values of Mark-Houwink coefficients for PP and PS are listed below in the Table below.

TABLE

| Polymer | A | Log K |
|---|---|---|
| Polypropylene | 0.725 | −3,721 |
| Polystyrene | 0.702 | −3,900 |

IZOD impact strength is measured in accordance with ASTM D 256 on specimens prepared in accordance with ASTM D4101.

The melting point or melting temperature and the crystallization temperature are determined using differential scanning calorimetry (DSC). The melting point is the primary peak that is formed during the test and is typically the second peak that forms. The term “crystallinity” refers to the regularity of the arrangement of atoms or molecules forming a crystal structure. Polymer crystallinity can be examined using DSC. Tₘₑ means the temperature at which the melting ends and Tₘₐₓ means the peak melting temperature, both as determined by one of ordinary skill in the art from DSC analysis using data from the final heating step. One suitable method for DSC analysis uses a model Q1000™ DSC from TA Instruments, Inc. Calibration of the DSC is performed in the following manner. First, a baseline is obtained by heating the cell from −90° C. to 290° C. without any sample in the aluminum DSC pan. Then 7 milligrams of a fresh indium sample is analyzed by heating the sample to 180° C., cooling the sample to 140° C. at a cooling rate of 10° C./min followed by keeping the sample isothermally at 140° C. for 1 minute, followed by heating the sample from 140° C. to 180° C. at a heating rate of 10° C./min. The heat of fusion and the onset of melting of the indium sample are determined and checked to be within 0.5° C. from 156.6° C. for the onset of melting and within 0.5 J/g from 28.71 J/g for the heat of fusion. Then deionized water is analyzed by cooling a small drop of fresh sample in the DSC pan from 25° C. to −30° C. at a cooling rate of 10° C./min. The sample is kept isothermally at −30° C. for 2 minutes and heated to 30° C. at a heating rate of 10° C./min. The onset of melting is determined and checked to be within 0.5° C. from 0° C.

One method of determining crystallinity in the high crystalline polypropylene polymer is by differential scanning calorimetry (DSC). A small sample (milligram size) of the propylene polymer is sealed into an aluminum DSC pan. The sample is placed into a DSC cell with a 25 centimeter per minute nitrogen purge and cooled to about −80° C. A standard thermal history is established for the sample by heating at 10° C. per minute to 225° C. The sample is then cooled to about −80° C. and reheated at 10° C. per minute to 225° C. The observed heat of fusion (ΔH_{observed}) for the second scan is recorded. The observed heat of fusion is related to the degree of crystallinity in weight percent based on the weight of the polypropylene sample by the following equation:

$$Crystallinity , \% = \frac{Δ {H}_{observed}}{Δ {H}_{isotactic PP}} \times 100$$

where the heat of fusion for isotactic polypropylene (ΔH_{isotactic PP}), as reported in B. Wunderlich, Macromolecular Physics, Volume 3, Crystal Melting, Academic Press, New Your, 1980, p 48, is 164.92 Joules per gram (J/g) of polymer.

Alternatively, crystallinity may also be determined using a heat of crystallization upon heating (HCH) method. In a HCH method, a sample is equilibrated at 200° C. and held at the temperature for three minutes. After the isothermal step, data storage is turned on, and the sample is ramped to −80° C. at 10° C. per minute. When −80° C. is reached, the data sampling is turned off, and the sample is held at the temperature for three minutes. After the second isothermal step, the data storage is turned on and the sample is ramped to 200° C. at 10° C. per minute.

In general, the present disclosure is directed to a polymer composition or polymer material for additive manufacturing, particularly for use in a three-dimensional extrusion printing system. The present disclosure is also directed to a printing cartridge, a three-dimensional printing system, and a method for forming three-dimensional articles from the polymer material. In general, the polymer material or polymer composition contains a polypropylene polymer. More particularly, the polymer composition contains a polypropylene random copolymer or random terpolymer containing one or more comonomers. The comonomers, for instance, can comprise alpha-olefin comonomers and can be ethylene, butene, or mixtures thereof.

The polymer composition of the present disclosure is capable of being employed as the polymer material in a three-dimensional printer system, particularly a printer system that uses material extrusion. For instance, the polypropylene polymer of the present disclosure is particularly formulated so as to display a minimal amount of shrinkage during melt processing in combination with many other desirable physical properties. Polymer articles made according to the present disclosure using a three-dimensional printing system, for instance, display little to no warpage.

In addition, the polypropylene random copolymer or terpolymer of the present disclosure offers many advantages over other thermoplastic polymers, especially polymers conventionally used in three-dimensional printing such as polylactic acid and ABS. For example, the polypropylene polymers of the present disclosure have better chemical resistance than polylactic acid polymers and ABS polymers. Compared to polylactic acid and ABS, the polypropylene polymer of the present disclosure also displays better interlayer adhesion between two adjacent fused layers during the three-dimensional printing process. In this manner, printed articles made according to the present disclosure can display improved mechanical strength. The polypropylene polymer of the present disclosure also does not emit volatile organic compounds during printing and is hydrophobic, preventing humidity from interfering with the printing process. The polypropylene polymers of the present disclosure are also relatively tough and display higher impact resistance than polylactic acid.

In formulating polypropylene polymers in accordance with the present disclosure, comonomers are introduced into the polymer chain in order to increase the xylene soluble content and reduce the crystallinity of the polymer. The reduced crystallinity reduces the shrinkage properties of the polymer and minimizes warpage of polymer articles formed according to a three-dimensional printing process. The crystallinity of the polypropylene polymer, for instance, can be less than about 50%, such as less than about 48%, such as less than about 46%, such as less than about 44%, such as less than about 42%, such as less than about 40%, such as less than about 38%. The crystallinity is generally greater than about 10%, such as greater than about 20%.

In one aspect, the polypropylene random copolymer or terpolymer of the present disclosure is made using a Ziegler-Natta catalyst. Although Ziegler-Natta catalyzed, the polypropylene polymer can be formulated to have a relatively narrow molecular weight distribution. Narrowing the molecular weight distribution of the polymer, for instance, is also believed to help control warpage issues during three-dimensional printing. Although unknown, it is believed that a narrow molecular weight distribution may provide less long chain molecules as nuclei in a shear-stressed crystallization during printing, which can slow down the crystallization rate and reduce shrinkage and warpage. In addition, it is believed that a polypropylene polymer with a narrow molecular weight distribution may have fewer tie chains connected to spherulites, which leads to less long-range shrinkage among spherulites during cooling. For example, the polypropylene polymer of the present disclosure can have a molecular weight distribution (Mw/Mn) of less than about 10, such as less than about 8, such as less than about 6, such as less than about 4, and generally greater than about 2, such as greater than about 2.5, such as greater than about 2.8, such as greater than about 3.

The polypropylene polymer of the present disclosure can include a majority weight percent propylene monomer combined with at least one comonomer. The comonomer can be one or more alpha-olefins. The comonomer, for instance, can be ethylene, can be butene, or can be a combination of ethylene and butene. The total comonomer content of the polypropylene polymer is generally greater than about 3%, such as greater than about 5%, such as greater than about 8%, and generally less than about 25%, such as less than about 18%.

In one aspect, the polypropylene polymer is a random copolymer of propylene and ethylene. The ethylene content of the propylene-ethylene random copolymer can be greater than about 3% by weight, such as greater than about 4% by weight, such as greater than about 5% by weight, such as greater than about 6% by weight, such as greater than about 7% by weight, and generally less than about 10% by weight, such as less than about 9% by weight.

Alternatively, the polypropylene polymer can be a propylene-butene random copolymer. The butene content of the copolymer can be greater than about 5% by weight, such as greater than about 7% by weight, such as greater than about 9% by weight, such as greater than about 11% by weight, such as greater than about 13% by weight, and generally less than about 20% by weight, such as less than about 18% by weight.

In still another embodiment, the polypropylene polymer can be a propylene-ethylene-butene terpolymer. The terpolymer can contain ethylene in an amount from about 1% to about 10% by weight and can contain butene in an amount from about 3% to about 20% by weight.

The polypropylene polymer of the present disclosure generally has a xylene soluble (XS) content of greater than about 4.5% by weight. For example, the polypropylene polymer can have a xylene soluble content of greater than about 7% by weight, such as greater than about 10% by weight, such as greater than about 12% by weight, such as greater than about 15% by weight, such as greater than about 17% by weight, such as greater than about 20% by weight, such as greater than about 22% by weight. The xylene soluble content is generally less than about 45% by weight, such as less than about 30% by weight.

The polypropylene polymer present in the composition can generally have a melt flow index (MFI) ranging from about 20 to about 100 g/10 min, though polypropylenes having a higher or lower melt flow index are also encompassed herein. For example, the polypropylene polymer may have a melt flow index of greater than about 25 g/10 min, such as greater than about 30 g/10 min, such as greater than about 35 g/10 min, such as greater than about 40 g/10 min. The melt flow index of the polypropylene polymer can be less than about 200 g/10 min, such as less than about 100 g/10 min, such as less than about 80 g/10 min, less than about 70 g/10 min, less than about 60 g/10 min, less than about 55 g/10 min.

The polypropylene polymer may be present in the polypropylene polymer composition in an amount of at least 50 wt. %, such as at least 60 wt. %, such as at least 70 wt. %, such as at least 80 wt. %, such as at least 90 wt. %, such as at least 95 wt. %, such as at least 96 wt. %. In one embodiment, the polypropylene polymer composition can contain almost exclusively the polypropylene polymer. For example, the polypropylene polymer can be present in an amount greater than about 96% by weight, such as in an amount greater than about 97% by weight, such as in an amount greater than about 98% by weight, such as in an amount greater than about 99% by weight.

In one embodiment, the polypropylene polymer of the present disclosure can be peroxide cracked, which can increase the melt flow rate and decrease the molecular weight distribution.

Peroxide cracking is also referred to as a visbreaking process. During visbreaking, higher molar mass chains of the polypropylene polymer are broken in relation to the lower molar mass chains. Visbreaking results in an overall decrease in the average molecular weight of the polymer and an increase in the melt flow rate. Visbreaking can produce a polymer with a lower molecular weight distribution or polydispersity index. The amount of visbreaking that occurs within the polymer can be quantified using a cracking ratio. The cracking ratio is calculated by dividing the final melt flow rate of the polymer by the initial melt flow rate of the polymer.

The random polypropylene copolymer can be subjected to visbreaking according to the present disclosure using a peroxide as a visbreaking agent. Typical peroxide visbreaking agents are 3,6,9-triethyl-3,6,9-trimethyl-1,4,7-triperoxonane, 2,5-dimethyl-2,5-bis(tert.butyl-peroxy)hexane (DHBP), 2,5-dimethyl-2,5-bis(tert.butyl-peroxy)hexyne-3 (DYBP), dicumyl-peroxide (DCUP), di-tert.butyl-peroxide (DTBP), tert.butyl-cumyl-peroxide (BCUP) and bis (tert.butylperoxy-isopropyl)benzene (DIPP). The above peroxides can be used alone or in a blend.

Visbreaking the random polypropylene copolymer can be carried out during melt processing in a first extruder. For instance, the random polypropylene copolymer can be fed through the extruder and the visbreaking agent can be added to the extruder once the polymer is in a molten state. Alternatively, the visbreaking agent can be preblended with the polypropylene polymer. In one aspect, for instance, the visbreaking agent can be first compounded with a polymer, such as a polypropylene polymer to form a masterbatch. The masterbatch containing the visbreaking agent can then be blended with the polypropylene polymer and fed through the extruder. In still another aspect, the visbreaking agent can be physically blended with the random polypropylene copolymer, such as being imbibed on the polymer powder. In general, any suitable extruder can be used during visbreaking. For instance, the extruder can be a single-screw extruder, a contra-rotating twin-screw extruder, a co-rotating twin-screw extruder, a planetary-gear extruder, a ring extruder, or any suitable kneading apparatus.

The amount of visbreaking agent added to the random polypropylene copolymer can depend upon various factors, including the cracking ratio that is desired. In general, the visbreaking agent or peroxide can be added to the random polypropylene copolymer or terpolymer in an amount greater than about 0.001% by weight, such as greater than about 0.005% by weight, such as greater than about 0.01% by weight, such as greater than about 0.015% by weight, such as greater than about 0.02% by weight, such as greater than about 0.04% by weight, such as greater than about 0.05% by weight, such as greater than about 0.08% by weight. In general, the visbreaking agent is added to the polypropylene polymer in an amount less than about 0.2% by weight, such as in an amount less than about 0.15% by weight, such as in an amount less than about 0.1% by weight.

The polypropylene polymer of the present disclosure can be formed in different ways. In one embodiment, the polymer is Ziegler-Natta catalyzed. The catalyst, for instance, can include a solid catalyst component that can vary depending upon the particular application.

The solid catalyst component can include (i) magnesium, (ii) a transition metal compound of an element from Periodic Table groups IV to VIII, (iii) a halide, an oxyhalide, and/or an alkoxide of (i) and/or (ii), and (iv) combinations of (i), (ii), and (iii). Nonlimiting examples of suitable catalyst components include halides, oxyhalides, and alkoxides of magnesium, manganese, titanium, vanadium, chromium, molybdenum, zirconium, hafnium, and combinations thereof.

In one embodiment, the preparation of the catalyst component involves halogenation of mixed magnesium and titanium alkoxides.

In various embodiments, the catalyst component is a magnesium moiety compound (MagMo), a mixed magnesium titanium compound (MagTi), or a benzoate-containing magnesium chloride compound (BenMag). In one embodiment, the catalyst precursor is a magnesium moiety (“MagMo”) precursor. The MagMo precursor includes a magnesium moiety. Nonlimiting examples of suitable magnesium moieties include anhydrous magnesium chloride and/or its alcohol adduct, magnesium alkoxide or aryloxide, mixed magnesium alkoxy halide, and/or carboxylated magnesium dialkoxide or aryloxide. In one embodiment, the MagMo precursor is a magnesium di(C₁₋₄)alkoxide. In a further embodiment, the MagMo precursor is diethoxymagnesium.

In another embodiment, the catalyst component is a mixed magnesium/titanium compound (“MagTi”). The “MagTi precursor” has the formula Mg_{d}Ti(OR^{e})fX_{g} wherein Re is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine, preferably chlorine; d is 0.5 to 56, or 2 to 4; f is 2 to 116 or 5 to 15; and g is 0.5 to 116, or 1 to 3. The precursors are prepared by controlled precipitation through removal of an alcohol from the reaction mixture used in their preparation. In an embodiment, a reaction medium comprises a mixture of an aromatic liquid, especially a chlorinated aromatic compound, most especially chlorobenzene, with an alkanol, especially ethanol. Suitable halogenating agents include titanium tetrabromide, titanium tetrachloride or titanium trichloride, especially titanium tetrachloride. Removal of the alkanol from the solution used in the halogenation, results in precipitation of the solid precursor, having especially desirable morphology and surface area. Moreover, the resulting precursors are particularly uniform in particle size.

In another embodiment, the catalyst precursor is a benzoate-containing magnesium chloride material (“BenMag”). As used herein, a “benzoate-containing magnesium chloride” (“BenMag”) can be a catalyst (i.e., a halogenated catalyst component) containing a benzoate internal electron donor. The BenMag material may also include a titanium moiety, such as a titanium halide. The benzoate internal donor is labile and can be replaced by other electron donors during catalyst and/or catalyst synthesis. Nonlimiting examples of suitable benzoate groups include ethyl benzoate, methyl benzoate, ethyl p-methoxybenzoate, methyl p-ethoxybenzoate, ethyl p-ethoxybenzoate, ethyl p-chlorobenzoate. In one embodiment, the benzoate group is ethyl benzoate. In an embodiment, the BenMag catalyst component may be a product of halogenation of any catalyst component (i.e., a MagMo precursor or a MagTi precursor) in the presence of a benzoate compound.

In another embodiment, the solid catalyst component can be formed from a magnesium moiety, a titanium moiety, an epoxy compound, an organosilicon compound, and an internal electron donor. In one embodiment, an organic phosphorus compound can also be incorporated into the solid catalyst component. For example, in one embodiment, a halide-containing magnesium compound can be dissolved in a mixture that includes an epoxy compound, an organic phosphorus compound, and a hydrocarbon solvent. The resulting solution can be treated with a titanium compound in the presence of an organosilicon compound and optionally with an internal electron donor to form a solid precipitate. The solid precipitate can then be treated with further amounts of a titanium compound. The titanium compound used to form the catalyst can have the following chemical formula:

Ti(OR)_{g}X_{4-g}

where each R is independently a C₁-C₄ alkyl; X is Br, Cl, or I; and g is 0, 1, 2, 3, or 4.

In some embodiments, the organosilicon is a monomeric or polymeric compound. The organosilicon compound may contain —Si—O—Si— groups inside of one molecule or between others. Other illustrative examples of an organosilicon compound include polydialkylsiloxane and/or tetraalkoxysilane. Such compounds may be used individually or as a combination thereof. The organosilicon compound may be used in combination with aluminum alkoxides and an internal electron donor.

The aluminum alkoxide referred to above may be of formula AI(OR′)₃ where each R′ is individually a hydrocarbon with up to 20 carbon atoms. This may include where each R′ is individually methyl, ethyl, n-propyl, iso-propyl, n-butyl, sec-butyl, tert-butyl, n-pentyl, iso-pentyl, neo-pentyl, etc.

Examples of the halide-containing magnesium compounds include magnesium chloride, magnesium bromide, magnesium iodide, and magnesium fluoride. In one embodiment, the halide-containing magnesium compound is magnesium chloride.

Illustrative of the epoxy compounds include, but are not limited to, glycidyl-containing compounds of the Formula:

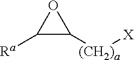

wherein “a” is from 1, 2, 3, 4, or 5, X is F, Cl, Br, I, or methyl, and Ra is H, alkyl, aryl, or cyclyl. In one embodiment, the alkylepoxide is epichlorohydrin. In some embodiments, the epoxy compound is a haloalkylepoxide or a nonhaloalkylepoxide.

In still another embodiment, a substantially spherical MgCl₂-nEtOH adduct may be formed by a spray crystallization process. In the process, a MgCl₂-nROH melt, where n is 1-6, is sprayed inside a vessel while conducting inert gas at a temperature of 20-80° C. into the upper part of the vessel. The melt droplets are transferred to a crystallization area into which inert gas is introduced at a temperature of −50 to 20° C. crystallizing the melt droplets into non agglomerated, solid particles of spherical shape. The spherical MgCl₂ particles are then classified into the desired size. Particles of undesired size can be recycled. In preferred embodiments for catalyst synthesis the spherical MgCl₂ precursor has an average particle size (Malvern d₅₀) of between about 15-150 microns, preferably between 20-100 microns, and most preferably between 35-85 microns.

The catalyst component may be converted to a solid catalyst by way of halogenation. Halogenation includes contacting the catalyst component with a halogenating agent in the presence of the internal electron donor. Halogenation converts the magnesium moiety present in the catalyst component into a magnesium halide support upon which the titanium moiety (such as a titanium halide) is deposited. Not wishing to be bound by any particular theory, it is believed that during halogenation the internal electron donor (1) regulates the position of titanium on the magnesium-based support, (2) facilitates conversion of the magnesium and titanium moieties into respective halides and (3) regulates the crystallite size of the magnesium halide support during conversion. Thus, provision of the internal electron donor yields a catalyst composition with enhanced stereoselectivity.

In an embodiment, the halogenating agent is a titanium halide having the formula Ti(OR^{e})_{f}Xₕ wherein Re and X are defined as above, f is an integer from 0 to 3; h is an integer from 1 to 4; and f+h is 4. In an embodiment, the halogenating agent is TiCl₄. In a further embodiment, the halogenation is conducted in the presence of a chlorinated or a non-chlorinated aromatic liquid, such as dichlorobenzene, o-chlorotoluene, chlorobenzene, benzene, toluene, or xylene. In yet another embodiment, the halogenation is conducted by use of a mixture of halogenating agent and chlorinated aromatic liquid comprising from 40 to 60 volume percent halogenating agent, such as TiCl₄.

In one embodiment, the resulting solid catalyst composition has a titanium content of from about 1.0 percent by weight to about 6.0 percent by weight, based on the total solids weight, or from about 1.5 percent by weight to about 4.5 percent by weight, or from about 2.0 percent by weight to about 3.5 percent by weight. The weight ratio of titanium to magnesium in the solid catalyst composition is suitably between about 1:3 and about 1:160, or between about 1:4 and about 1:50, or between about 1:6 and 1:30. In an embodiment, the internal electron donor may be present in the catalyst composition in a molar ratio of internal electron donor to magnesium of from about 0.005:1 to about 1:1, or from about 0.01:1 to about 0.4:1. Weight percent is based on the total weight of the catalyst composition.

As described above, the catalyst composition can include a combination of a magnesium moiety, a titanium moiety and the internal electron donor. The catalyst composition is produced by way of the foregoing halogenation procedure which converts the catalyst component and the internal electron donor into the combination of the magnesium and titanium moieties, into which the internal electron donor is incorporated. The catalyst component from which the catalyst composition is formed can be any of the above described catalyst precursors, including the magnesium moiety precursor, the mixed magnesium/titanium precursor, the benzoate-containing magnesium chloride precursor, the magnesium, titanium, epoxy, and phosphorus precursor, or the spherical precursor.

Various different types of internal electron donors may be incorporated into the solid catalyst component. In one embodiment, the internal electron donor is an aryl diester, such as a phenylene-substituted diester. In one embodiment, the internal electron donor may have the following chemical structure:

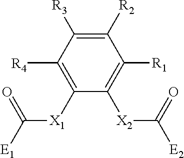

wherein R₁ R₂, R₃ and R₄ are each a hydrocarbyl group having from 1 to 20 carbon atoms, the hydrocarbyl group having a branched or linear structure or comprising a cycloalkyl group having from 7 to 15 carbon atoms, and where E₁ and E₂ are the same or different and selected from the group consisting of an alkyl having 1 to 20 carbon atoms, a substituted alkyl having 1 to 20 carbon atoms, an aryl having 1 to 20 carbon atoms, a substituted aryl having 1 to 20 carbon atoms, or an inert functional group having 1 to 20 carbon atoms and optionally containing heteroatoms, and wherein X1 and X2 are each O, S, an alkyl group, or NR₅ and wherein R₅ is a hydrocarbyl group having 1 to 20 carbon atoms or is hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

In one aspect, the substituted phenylene diester has the following structure (I):

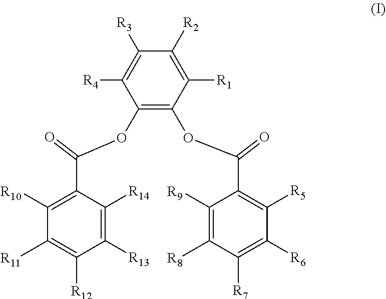

In an embodiment, structure (I) includes R₁ and R₃ that is an isopropyl group. Each of R₂, R₄ and R₅-R₁₄ is hydrogen.

In an embodiment, structure (I) includes each of R₁ and R₄, as a methyl group and R₃ is a cycloalkyl group, such as a cyclohexyl group. Each of R₂ and R₅-R₁₄ are hydrogen.

In an embodiment, structure (I) includes each of R₁, R₅, and R₁₀ as a methyl group and R₃ is a t-butyl group. Each of R₂, R₄, R₆-R₉ and R₁₁-R₁₄ is hydrogen.

In an embodiment, structure (I) includes each of R₁, R₇, and R₁₂ as a methyl group and R₃ is a t-butyl group. Each of R₂, R₄, R₅, R₆, R₈, R₉, R₁₀, R₁₁, R₁₃, and R₁₄ is hydrogen.

In an embodiment, structure (I) includes R₁ as a methyl group and R₃ is a t-butyl group. Each of R₇ and R₁₂ is an ethyl group. Each of R₂, R₄, R₅, R₆, R₈, R₉, R₁₀, R₁₁, R₁₃, and R₁₄ is hydrogen.

In an embodiment, structure (I) includes each of R₁, R₅, R₇, R₉, R₁₀, R₁₂, and R₁₄ as a methyl group and Re is a t-butyl group. Each of R₂, R₄, R₆, R₈, R₁₁, and R₁₃ is hydrogen.

In an embodiment, structure (I) includes R₁ as a methyl group and R₃ is a t-butyl group. Each of R₅, R₇, R₉, R₁₀, R₁₂, and R₁₄ is an i-propyl group. Each of R₂, R₄, R₆, R₈, R₁₁, and R₁₃ is hydrogen.

In an embodiment, the substituted phenylene aromatic diester has a structure selected from the group consisting of structures (II)-(V), including alternatives for each of R₁ to R₁₄, that are described in detail in U.S. Pat. No. 8,536,372, which is incorporated herein by reference.

In an embodiment, structure (I) includes R₁ that is a methyl group and R₃ is a t-butyl group. Each of R- and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a fluorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a chlorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group, Each of R₇ and R₁₂ is a bromine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an iodine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₆, R₇, R₁, and R₁₂ is a chlorine atom. Each of R₂, R₄, R₅, R₇, R₉, R₁₀, R₁₃, and R₁₄ is hydrogen.

In an embodiment, structure (I) includes R₁ that is a methyl group and R₃ is a t-butyl group. Each of R₆, R₈, R₁₁, and R₁₃ is a chlorine atom. Each of R₂, R₄, R₅, R₇, R₉, R₁₀, R₁₂, and R₁₄ is hydrogen.

In an embodiment, structure (I) includes R₁ that is a methyl group and R₃ is a t-butyl group. Each of R₂, R₄ and R₅-R₁₄ is a fluorine atom.

In an embodiment, structure (I) includes R₁ that is a methyl group and R₃ is a t-butyl group. Each of R₇ and R₁₂ is a trifluoromethyl group. Each of R₂, R₄, R₅, R₆, R₈, R₁₀, R₁₁, R₁, and R₁₄ is hydrogen.

In an embodiment, structure (I) includes R₁ that is a methyl group and Ra is a t-butyl group. Each of R₇ and R₁₂ is an ethoxycarbonyl group. Each of R₂, R₄, R₅, R₆, R₈, R₉, R₁₀, R₁₁, R₁₃, and R₁₄ is hydrogen.

In an embodiment, R₁ is methyl group and R₃ is a t-butyl group. Each of R₇ and R₁₂ is an ethoxy group. Each of R₂, R₄, R₅, R₆, R₈, R₉, R₁₀, R₁₁, R₁₃ and R₁₄ is hydrogen.

In an embodiment, structure (I) includes R₁ that is a methyl group and R₃ is a t-butyl group, Each of R₇ and R₁₂ is a diethylamino group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a 2,4,4-trimethylpentan-2-yl group. Each of R₂, R₄ and R₅-R₁₄ is hydrogen.

In an embodiment, structure (I) includes R₁ and R₃, each of which is a sec-butyl group. Each of R₂, R₄ and R₅-R₁₄ is hydrogen.

In an embodiment, structure (I) includes R₁ and R₄ that are each a methyl group. Each of R₂, R₃, R₅-R₉ and R₁-R₁₄ is hydrogen.

In an embodiment, structure (I) includes R₁ that is a methyl group. R₄ is an i-propyl group. Each of R₂, R₃, R₅-R₉ and R₁₀-R₁₄ is hydrogen.

In an embodiment, structure (I) includes R₁, R₃, and R₄, each of which is an i-propyl group. Each of R₂, R₅-R₉ and R₁₀-R₁₄ is hydrogen.

In addition to the solid catalyst component as described above, the catalyst system of the present disclosure can also include a cocatalyst. The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In an embodiment, the cocatalyst is selected from triethylaluminum, triisobutylaluminum, tri-n-hexylaluminum, diisobutylaluminum hydride, and di-n-hexylaluminum hydride.

In an embodiment, the cocatalyst is triethylaluminum. The molar ratio of aluminum to titanium is from about 5:1 to about 500:1, or from about 10:1 to about 200:1, or from about 15:1 to about 150:1, or from about 20:1 to about 100:1. In another embodiment, the molar ratio of aluminum to titanium is about 45:1.

Suitable catalyst compositions can include the solid catalyst component, a co-catalyst, and an external electron donor that can be a mixed external electron donor (M-EED) of two or more different components. Suitable external electron donors or “external donor” include one or more activity limiting agents (ALA) and/or one or more selectivity control agents (SCA). As used herein, an “external donor” is a component or a composition comprising a mixture of components added independent of procatalyst formation that modifies the catalyst performance. As used herein, an “activity limiting agent” is a composition that decreases catalyst activity as the polymerization temperature in the presence of the catalyst rises above a threshold temperature (e.g., temperature greater than about 95° C.). A “selectivity control agent” is a composition that improves polymer tacticity, wherein improved tacticity is generally understood to mean increased tacticity or reduced xylene solubles or both. It should be understood that the above definitions are not mutually exclusive and that a single compound may be classified, for example, as both an activity limiting agent and a selectivity control agent.

A selectivity control agent in accordance with the present disclosure is generally an organosilicon compound. For example, in one aspect, the selectively control agent can be an alkoxysilane.

In one embodiment, the alkoxysilane can have the following general formula: SiRₘ(OR′)₄₋ₘ (I) where R independently each occurrence is hydrogen or a hydrocarbyl or an amino group optionally substituted with one or more substituents containing one or more Group 14, 15, 16, or 17 heteroatoms, said R containing up to 20 atoms not counting hydrogen and halogen; R′ is a C₁₋₄ alkyl group; and m is 0, 1, 2 or 3. In an embodiment, R is C₆₋₁₂ aryl, alkyl or aralkyl, C₃₋₁₂ cycloalkyl, C₃₋₁₂ branched alkyl, or C₃₋₁₂ cyclic or acyclic amino group, R′ is C₁₋₄ alkyl, and m is 1 or 2. In one embodiment, for instance, the second selectivity control agent may comprise n-propyltriethoxysilane. Other selectively control agents that can be used include propyltriethoxysilane or diisobutyldimethoxysilane.

In one embodiment, the catalyst system may include an activity limiting agent (ALA). An ALA inhibits or otherwise prevents polymerization reactor upset and ensures continuity of the polymerization process. Typically, the activity of Ziegler-Natta catalysts increases as the reactor temperature rises. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester. The aliphatic carboxylic acid ester may be a C₄-C₃₀ aliphatic acid ester, may be a mono- or a poly- (two or more) ester, may be straight chain or branched, may be saturated or unsaturated, and any combination thereof. The C₄-C₃₀ aliphatic acid ester may also be substituted with one or more Group 14, 15 or 16 heteroatom containing substituents. Nonlimiting examples of suitable C_{4-C30} aliphatic acid esters include C₁₋₂₀ alkyl esters of aliphatic C₄₋₃₀ monocarboxylic acids, C₁₋₂₀ alkyl esters of aliphatic C₈₋₂₀ monocarboxylic acids, C₁₋₄ allyl mono- and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₄₋₂₀ mono- or polycarboxylate derivatives of C₂₋₁₀₀ (poly)glycols or C₂₋₁₀₀ (poly)glycol ethers. In a further embodiment, the C₄-C₃₀ aliphatic acid ester may be a laurate, a myristate, a palmitate, a stearate, an oleates, a sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-oleates, glyceryl tri(acetate), glyceryl tri-ester of C₂₋₄₀ aliphatic carboxylic acids, and mixtures thereof. In a further embodiment, the C₄-C₃₀ aliphatic ester is isopropyl myristate, di-n-butyl sebacate and/or pentyl valerate.

The catalyst system of the present disclosure as described above can be used for producing olefin-based polymers. The process includes contacting an olefin with the catalyst system under polymerization conditions.

Polypropylene random copolymers and terpolymers made according to the present disclosure can then be incorporated into various polymer compositions for producing a feed stock having a size and shape configured for being fed into a three-dimensional printing system. The feed stock can be in the form of polymer pellets, a polymer rod or a continuous filament. The polymer composition used to produce the filament can contain the polypropylene polymer alone or in combination with various other additives and components.

For example, in one embodiment, the polymer composition can contain one or more fillers. The filler, for instance, can be a non-organic filler. Fillers that may be contained in the polymer composition include talc particles, calcium carbonate particles, glass fibers, metals and alloys or mixtures thereof. One or more fillers can be included in the polymer composition in an amount greater than about 0% by weight, such as in an amount greater than about 2% by weight, such as in an amount greater than about 5% by weight, and generally in an amount less than about 40% by weight, such as in an amount less than about 20% by weight, such as in an amount less than about 10% by weight, such as in an amount less than about 8% by weight, such as in an amount less than about 6% by weight.

In one aspect, the polymer composition can contain a primary antioxidant, a secondary antioxidant (e.g. phosphite), and an antacid (e.g. CaSt or ZnO). In one aspect, the antioxidant has anti-gas fading properties such as Irganox 3114, Cyanox 1790, or Irganox 1425WL. Alternately, the antioxidant system can be non-gas fading, i.e. free of phenolic antioxidants, and be based on a combination of HALS (hindered amine light stabilizer) with either/both a hydroxylamine stabilizer (e.g. Irganox FS042) and a phosphite secondary antioxidant. The antioxidant can minimize the oxidation of polymer components and organic additives in the polymer blends. The polymer composition, for instance, can contain a phosphite and/or phosphonate antioxidant alone or in combination with other antioxidants. Non-limiting examples of suitable antioxidants include phenols such as 2,6-di-t-butyl-4-methylphenol; 1,3,5-trimethyl-2,4,6-tris(3′,5′-di-t-butyl-4′-hydroxybenzyl)benzene; tetrakis[(methylene(3,5-di-t-butyl-4-hydroxyhydrocinnamate)]methane; acryloyl modified phenols; octadecyl-3,5-di-t-butyl-4-hydroxycinnamate; 1,3,5-tris(3,5-di-tert-butyl-4-hydroxybenzyl)-1,3,5-triazine-2,4,6(1H,3H,5H)-trione (e.g. Irganox 3114 supplied by BASF); calcium-bis (((3,5-bis(1,1-dimethylethyl)-4-hydroxyphenyl)methyl)-ethylphosphonate) (e.g. Irganox 1425WL supplied by BASF). Another antioxidant than may be used is 1,3,5-triazine-2,4,6(1H,3H,5H)-trione, 1,3,5-tris[[4-(1,1-dimethylethyl)-3-hydroxy-2,6-dimethylphenyl]methyl] (e.g. Cyanox 1790 from Sovay). In another aspect the antioxidant can be N,N-dioctadecylhydroxylamine (e.g. FS042). Phosphites and phosphonites may generally be used in combination with the above hindered phenols; hydroxylamines may generally be used in combination with a hindered amine light stabilizer or a phosphite. Other antioxidants include benzofuranone derivatives; and combinations thereof.

The polymer composition can also contain an antacid which operates as an acid scavenger. The antacid can be a stearate, a metal oxide, a hydrotalcite, magnesium aluminum hydroxide carbonate, or mixtures thereof. Examples of particular antacids include calcium stearate, zinc stearate, magnesium oxide, zinc oxide, and mixtures thereof.

In some embodiments, the polymer composition may include a lubricant. Non-limiting examples of suitable lubricants include fatty alcohols and their dicarboxylic acid esters, fatty acid esters of short-chain alcohols, fatty acids, fatty acid amides, metal soaps, oligomeric fatty acid esters, fatty acid esters of long-chain alcohols, montan waxes, polyethylene waxes, polypropylene waxes, natural and synthetic paraffin waxes, and combinations thereof. One embodiment of a fatty acid amide lubricant that may be used is N,N′Ethylene bisstearamide. If included in sufficient amounts, various stearates may also serve as lubricants. For example, higher levels of a metal stearate, such as zinc stearate, may serve as an internal lubricant.

The polymer composition can also contain a processing aid. An example of a processing aid is a fluorocarbon polymer. For instance, the composition can contain polytetrafluoroethylene particles. The processing aid can be present in an amount of from about 0% to about 5% by weight, such as from about 0.01% to about 1.5% by weight.

In some embodiments, the polymer composition can optionally include a stabilizer that may prevent or reduce the degradation of the polymer blends by UV radiation. Non-limiting examples of suitable UV stabilizers include benzophenones, hindered amines, benzotriazoles, aryl esters, oxanilides, acrylic esters, formamidines, carbon black, nickel quenchers, phenolic antioxidants, metallic salts, zinc compounds and combinations thereof.

In one aspect, the polymer composition can also contain one or more coloring agents. The coloring agent can be a dye or a pigment. In one embodiment, a blend of coloring agents can be used in order to produce a filament with a particular color.

In one embodiment, the polymer composition can contain a nucleating agent. When utilized, the nucleating agent is not particularly limited. In one embodiment, the nucleating agent may be selected from the group of phosphorous based nucleating agents like phosphoric acid esters metal salts represented by the following structure (VIII).

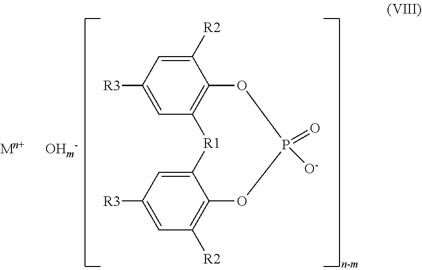

wherein R1 is oxygen, sulfur or a hydrocarbon group of 1 to 10 carbon atoms; each of R2 and R3 is hydrogen or a hydrocarbon or a hydrocarbon group of 1 to 10 carbon atoms; R2 and R3 may be the same or different from each other, two of R2, two of R3, or R2 and R3 may be bonded together to form a ring, M is a monovalent to trivalent metal atom; n is an integer from 1 to 3 and m is either 0 or 1, provided that n>m.

Examples of alpha nucleating agents represented by the above formula include sodium-2,2′-methylene-bis(4,6-di-t-butyl-phenyl)phosphate, sodium-2,2′-ethylidene-bis(4,6-di-t-butylphenyl)-phos-phate, lithium-2,2′-methylene-bis(4,6-di-t-butylphenyl)phosphate, lithium-2,2′-ethylidene-bis(4,6-di-t-butylphenyl)phosphate, sodium-2,2′-ethylidene-bis(4-i-propyl-6-t-butylphenyl)phosphate, lithium-2,2′-methylene-bis(4-methyl-6-t-butylphenyl)phosphate, lithium-2,2′-methylene-bis(4-ethyl-6-t-butylphenyl)phosphate, calcium-bis[2,2′-thiobis(4-methyl-6-t-butyl-phenyl)-phosphate], calcium-bis[2,2′-thiobis(4-ethyl-6-t-butylphenyl)-phosphate], calcium-bis[2,2′-thiobis(4,6-di-t-butylphenyl)phosphate], magnesium-bis[2,2′-thiobis(4,6-di-t-butylphenyl)phosphate], magnesium-bis[2,2′-thiobis(4-t-octylphenyl)phosphate], sodium-2,2′-butylidene-bis(4,6-dimethylphenyl)phosphate, sodium-2,2′-butylidene-bis(4,6-di-t-butyl-phenyl)-phosphate, sodium-2,2′-t-octylmethylene-bis(4,6-dimethyl-phenyl)-phosphate, sodium-2,2′-t-octylmethylene-bis(4,6-di-t-butylphenyl)-phos-phate, calcium-bis[2,2′-methylene-bis(4,6-di-t-butylphenyl)-phosphate], magnesium-bis[2,2′-methylene-bis(4,6-di-t-butylphenyl)-phosphate], barium-bis[2,2′-methylene-bis(4,6-di-t-butylphenyl)-phosphate], sodium-2,2′-methylene-bis(4-methyl-6-t-butylphenyl)-phosphate, sodium-2,2′-methylene-bis(4-ethyl-6-t-butylphenyl)phosphate, sodium(4,4′-dimethyl-5,6′-di-t-butyl-2,2′-biphenyl)phosphate, calcium-bis-[(4,4′-dimethyl-6,6′-di-t-butyl-2,2′-biphenyl)phosphate], sodium-2,2′-ethyli-dene-bis(4-m-butyl-6-t-butyl-phenyl)phosphate, sodium-2,2′-methylene-bis-(4,6-di-methylphenyl)-phos-phate, sodium-2,2′-methylene-bis(4,6-di-t-ethyl-phenyl)phosphate, potassium-2,2′-ethylidene-bis(4,6-di-t-butylphenyl)-phosphate, calcium-bis[2,2′-ethylidene-bis(4,6-di-t-butylphenyl)-phosphate], magnesium-bis[2,2′-ethyli-dene-bis(4,6-di-t-butylphenyl)-phosphate], barium-bis[2,2′-ethylidene-bis-(4,6-di-t-butylphenyl)-phosphate], aluminium-hydroxy-bis[2,2′-methylene-bis(4,6-di-t-butyl-phenyl)phosphate], aluminium-tris[2,2′-ethylidene-bis(4,6-di-t-butylphenyl)-phosphate].

A second group of phosphorous based nucleating agents includes for example aluminium-hydroxy-bis[2,4,8,10-tetrakis(1,1-dimethylethyl)-6-hydroxy-12H-dibenzo-[d,g]-dioxa-phoshocin-6-oxidato] and blends thereof with Li-myristate or Li-stearate.

Other examples of nucleating agents can include, without limitation, sorbitol-based nucleating agents (e.g., 1,3:2,4 Dibenzylidene sorbitol, 1,3:2,4 Di(methylbenzylidene) sorbitol, 1,3:2,4 Di(ethylbenzylidene) sorbitol, 1,3:2,4 Bis(3,4-dimethylbenzylidene) sorbitol, etc.), pine rosin, polymeric nucleating agents (e.g., vinylcycloalkane polymers, vinylalkane polymers, partial metal salts of a rosinic acid, etc.), talc, sodium benzoate, etc.

Commercially available examples of nucleating agents can include, without limitation, ADK STAB NA-11, ADK STAB NA-21, ADK STAB NA-21 E, ADK STAB NA-21 F, and ADK STAB NA-27 which are available from Asahi Denka Kokai; Millad NX8000, Millad 3988, Millad 3905, Millad 3940, Hyperform HPN-68L, Hyperform HPN-715, and Hyperform HPN-20E, which are available from Milliken & Company; and Irgaclear XT 386 from Ciba Specialty Chemicals.

In one embodiment, the nucleating agent may comprise a sorbitol compound, such as a sorbitol acetal derivative. In one embodiment, for instance, the nucleating agent may comprise a dibenzyl sorbitol.

With regard to sorbitol acetal derivatives that can be used as an additive in some embodiments, the sorbitol acetal derivative is shown in structure (IX):

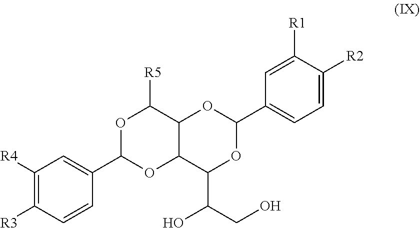

wherein R1-R5 comprise the same or different moieties chosen from hydrogen and a C1-C3 alkyl.

In some embodiments, R1-R5 are hydrogen, such that the sorbitol acetal derivative is 2,4-dibenzylidene sorbitol (“DBS”). In some embodiments, R1, R4, and R5 are hydrogen, and R2 and R3 are methyl groups, such that the sorbitol acetal derivative is 1,3:2,4-di-p-methyldibenzylidene-D-sorbitol (“MDBS”). In some embodiments, R1-R4 are methyl groups and R5 is hydrogen, such that the sorbitol acetal derivative is 1,3:2,4-Bis (3,4-dimethylobenzylideno) sorbitol (“DMDBS”). In some embodiments, R2, R3, and R5 are propyl groups (—CH₂-CH₂-CH₃), and R1 and R4 are hydrogen, such that the sorbitol acetal derivative is 1,2,3-trideoxy-4,6:5,7-bis-O-(4-propylphenyl methylene) nonitol (“TBPMN”).

Other examples of nucleating agents that may be used include, without limitation, 1,3:2,4-dibenzylidene sorbitol, 1,3:2,4-bis(p-methylbenzylidene) sorbitol, di(p-methylbenzylidene) sorbitol, di(p-ethylbenzylidene) sorbitol, bis(5′,6′,7′,8′-tetrahydro-2-naphtylidene) sorbitol, a bisamide, such as benzenetrisamide, as well as any combination of nucleating agents.

When present in the polymer composition, one or more nucleating agents are generally added in an amount greater than about 0 ppm, such as in amount greater than about 200 ppm, such as in an amount greater than about 1,800 ppm, such as in an amount greater than about 2,000 ppm, such as in an amount greater than about 2,200 ppm. One or more nucleating agents are generally present in an amount less than about 20,000 ppm, such as less than about 15,000 ppm, such as less than about 10,000 ppm, such as less than about 8,000 ppm, such as less than about 5,000 ppm.

Once the polymer composition is formulated, the polymer composition can be melt processed into a feed stock. The feed stock can comprise polymer pellets or a polymer rod. In one embodiment, the feed stock can comprise an extruded filament. The feed stock can be incorporated into a printer cartridge that is readily adapted for incorporation into a three-dimensional printer system.

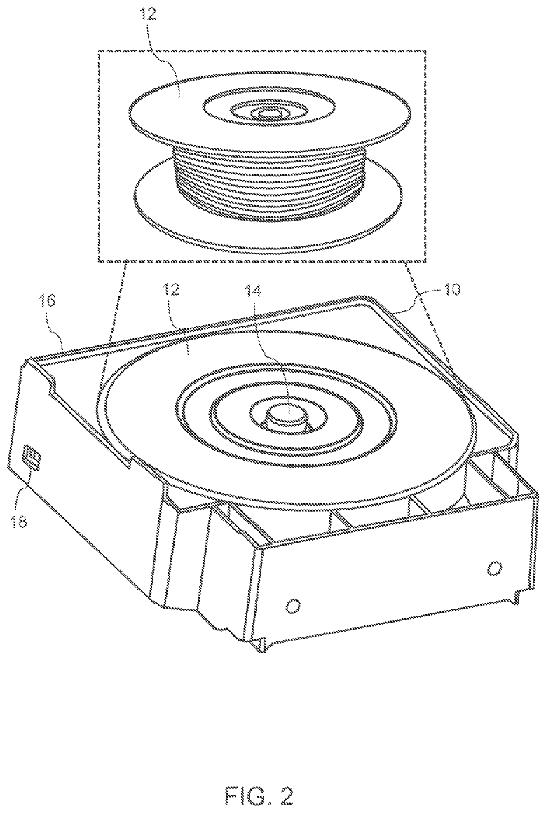

For example, referring to FIG. 2, one embodiment of a printer cartridge 10 is illustrated. For exemplary purposes only, the cartridge 10 shown in FIG. 2 is particularly adapted for receiving a polymer filament as a feed stock. The printer cartridge 10, for example, includes a spool 12. When the polymer composition of the present disclosure is in the form of a filament, the filament can be wound around the spool 12. The spool 12 can define a central bore which fits around an axle 14 within the printer cartridge 10.

As shown in FIG. 2, although not necessary, the spool 12 can be enclosed within a housing 16 that protects the filament from the exterior environment prior to use.

The printer cartridge 10 can have a shape and configuration well suited for use in a particular type of printing system. In one embodiment, for instance, the printer cartridge 10 can include an identifying device 18 that allows a printer system to identify the printer cartridge. The identifying device 18, for instance, may comprise a machine readable component, such as a machine readable chip.

As described above, the polymer composition of the present disclosure is particularly well suited for use in producing articles via a three-dimensional printer.

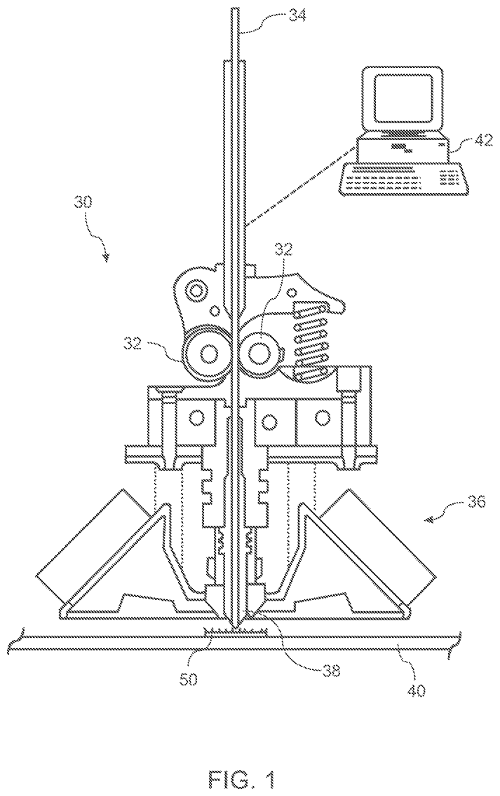

Generally speaking, any of a variety of three-dimensional printer systems can be employed in the present disclosure to produce three-dimensional articles. Referring to FIG. 1, for example, one embodiment of an extrusion-based, three-dimensional printer system 30 is shown that may be configured to receive the printer cartridge 10 as shown in FIG. 2. The printer system 30 includes a pair of feed rollers 32 that engage a polymer material 34. The polymer material 34 is made from the polymer composition of the present disclosure. In this embodiment, the polymer material 34 is in the form of a filament. The feed rollers 32 can rotate clockwise and/or counterclockwise at a desired rate in order to feed and retract the filament 34 in very precise amounts into the downstream process. From the feed rollers 32, the filament 34 is fed to a heating device 36 positioned upstream from a nozzle 38. The heating device 36 melts the filament to a useable temperature. The nozzle 38 extrudes the filament 34 onto a platform 40. In general, the polymer material 34 exits the nozzle 38 at a diameter smaller than the filament that is fed to the nozzle. The nozzle 38 and/or the platform 40 are then moved in a pattern in order to form a three-dimensional article in a layer-by-layer manner. In one embodiment, the nozzle 38 and/or the platform 40 are moved not only in the X and Y plane but also in the Z plane.

The printing system 30 can also include a controller 42 which may comprise one or more programmable devices or microprocessors. The controller 42 can store a particular pattern and then control the printing system 30 in order to deposit the polymer material onto the platform 40 in a desired manner for forming a three-dimensional article 50.

As shown in FIG. 1, during the printing process, the polymer material 34 is heated to a molten state. The filament deposits onto the platform 40 in a layer-by-layer manner and thermally bonds with each successive layer.

The present disclosure may be better understood with reference to the following example.

### Example

Twelve different polypropylene polymers were formed into filaments and tested using a three-dimensional printer. The twelve different samples are shown in the table below (Sample Nos. 1-12), including chemical composition and various properties of the polymers. Sample No. 13 represents a commercially available polypropylene filament for three-dimensional printing.

| Examples | Sample #1 | Sample #2 | Sample #3 | Sample #4 | Sample #5 | Sample #6 |
|---|---|---|---|---|---|---|
| Pellets MFR | 47.4 | 48.5 | 48 | 24 | 3.1 | 3.5 |
| (g/10 min) | | | | | | |
| Mw/Mn | 3.3 | 3.3 | 5.4 | 5.4 | 5.4 | 5.4 |
| Et (wt %) | 7.4 | 5.3 | 5.2 | 3.8 | 7.3 | 5.2 |
| Bt (wt %) | 0 | 0 | 0 | 0 | 0 | 0 |
| XS (wt %) | 25.3 | 13.2 | 10.0 | 5.3 | 23.8 | 9.2 |
| Tc (° C.) | 89 | 102 | 101 | 105 | 87 | 102 |
| Tm (° C.) | 124 | 135 | 135 | 141 | 124 | 134 |

| | | | | | | | Sample #13 |
|---|---|---|---|---|---|---|---|
| Examples | Sample #7 | Sample #8 | Sample #9 | Sample #10 | Sample #11 | Sample #12 | (comparative) |
| Pellets MFR | 51 | 9.7 | 4 | 3.6 | 22.118 | 20.405 | 18 |
| (g/10 min) | | | | | | | |
| Mw/Mn | 5.1 | 6.3 | 5.4 | 5.1 | 3.8 | 3.8 | 3.2 |
| Et (wt %) | 2.7 | 3.6 | 0 | 0.8 | 0 | 0.8 | 6.4 |
| Bt (wt %) | 0 | 0 | 16.5 | 13.2 | 16.5 | 13.2 | n.a. |
| XS (wt %) | 4.9 | 5.2 | 56.7 | 32.3 | 43.1 | 35.4 | 27.2 |
| Tc (° C.) | 110 | 101 | 91 | 81 | 95 | 84 | 88 |
| Tm (° C.) | 146 | 141 | 128 | 117 | 129 | 119 | 128 |

Note:
The Et of Sample #13 was tested by ¹³C-NMR, while all the others were tested by FTIR. The XS content of Sample #13 was tested by a wet method, while all the others were tested by the Viscotek FIPA method.

Three-dimensional (3D) printing filaments were extruded from sample pellets on a Wellzoom B2 desktop filament extruder with a Wellzoom auto winder. The diameter of the filaments was controlled at 1.75 mm±0.05 mm.

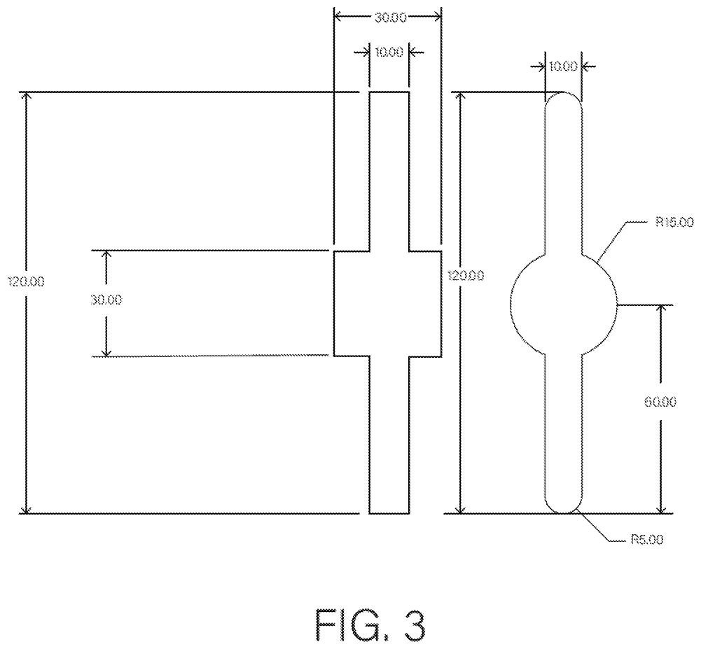

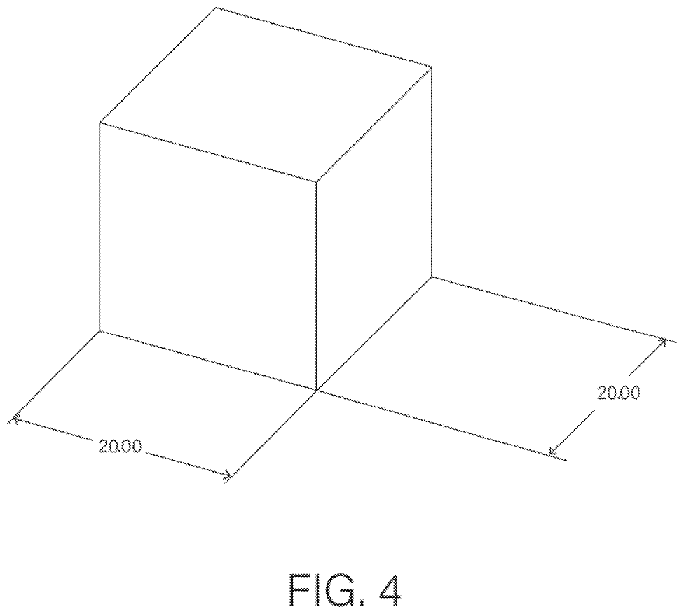

The 3D printing processes were finished on the Creality 3D Ender 2 3D printer. The printed parts have three model targets for different testing purposes (See FIGS. 3 and 4; dimensions in mm):

Warpage testing: Testing bars (FIG. 3) with thin thickness (z-direction during printing) were designed to test the warpage height. As shown in FIG. 3, the model with a square center is Model #1, and the one with a round center is Model #2. The warpage height is distance measured from the center part of the testing bar to the substrate when the testing bar is positioned upside down. The higher warpage height represents the more severe warpage.

Bulk shrinkage testing: Testing cubes (FIG. 4) with thick thickness (z-direction during printing) were designed to test the bulk shrinkage. The 3D model of the cube is shown in FIG. 4. Different scores scaled from 1 to 5 (1 is worst and 5 is best) were given to the printed cubes in view of bottom deformation, surface finish and top seal. The total score was scaled from 0 to 15 and is the sum of the three above mentioned scores.

During three-dimensional printing, the nozzle diameter was set at 0.4 mm, the nozzle temperature was set at 230° C., the layer thickness was set at 0.3 mm, and the bed temperature was set at 60° F. The bed material used was a pressure sensitive polypropylene tape that was used for adhesion to the article as it was formed. The printing speed was 2,400 mm/min. The outline speed was set at 50%, the first layer speed was set at 20% and the height was set at 90%. The ooze control retraction was disabled, and the interior fill percentage was set at 20%.

| Examples | | Sample #1 | Sample #2 | Sample #3 | Sample #4 | Sample #5 | Sample #6 |
|---|---|---|---|---|---|---|---|
| Warpage | Warpage | 3.1 | 4.1 | 5.8 | 5.9 | 3.5 | 4.4 |
| Testing | Height (mm, | | | | | | |
| | Model #1) | | | | | | |
| | Warpage | 2.4 | 3.3 | 5.2 | 5.7 | 8.4 | 4.6 |
| | Height (mm, | | | | | | |
| | Model #2) | | | | | | |
| Bulk | Bottom | 5 | 4 | 3 | 4 | 5 | 4 |
| Shrinkage | Deformation | | | | | | |
| Testing | Surface | 5 | 5 | 3 | 3 | 1 | 1 |
| | Finish | | | | | | |
| | Top Seal | 3 | 3 | 3 | 5 | 2 | 1 |
| | Total Score | 13 | 12 | 9 | 12 | 8 | 6 |

| | | | | | | | | Sample #13 |
|---|---|---|---|---|---|---|---|---|
| Examples | | Sample #7 | Sample #8 | Sample #9 | Sample #10 | Sample #11 | Sample #12 | (comparative) |
| Warpage | Warpage | 10.8 | 7.5 | 4.4 | 4.6 | 3.85 | 3.15 | 3 |
| Testing | Height (mm, | | | | | | | |
| | Model #1) | | | | | | | |
| | Warpage | Failed to | 5.8 | 3.5 | 4.5 | 3.65 | 3.25 | 2.5 |
| | Height (mm, | print due to | | | | | | |
| | Model #2) | detach | | | | | | |
| Bulk | Bottom | Detached | 2 | 5 | 5 | 4 | 4 | 5 |
| Shrinkage | Deformation | from | | | | | | |
| Testing | | bottom | | | | | | |
| | Surface | N/A | 2 | 1 | 1 | 4 | 3 | 3 |
| | Finish | | | | | | | |
| | Top Seal | N/A | 3 | 1 | 1 | 4 | 3 | 1 |
| | Total Score | N/A | 7 | 7 | 7 | 12 | 10 | 9 |

Based on the warpage height from warpage testing (smaller warpage height is preferred) and total score from bulk shrinkage testing (higher score is preferred), Sample #1 shows the best printing performance.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

The present technology is also not to be limited in terms of the particular aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to particular methods, reagents, compounds, compositions, labeled compounds or biological systems, which can, of course, vary. It is also to be understood that the terminology used herein is for the purpose of describing particular aspects only, and is not intended to be limiting. Thus, it is intended that the specification be considered as exemplary only with the breadth, scope and spirit of the present technology indicated only by the appended claims, definitions therein and any equivalents thereof.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present technology may include, but is not limited to, the features and combinations of features recited in the following lettered paragraphs, it being understood that the following paragraphs should not be interpreted as limiting the scope of the claims as appended hereto or mandating that all such features must necessarily be included in such claims:
A. A polymer material for a three-dimensional extrusion printing system, the polymer material comprising a feed stock having a size and shape suitable for feeding to a three-dimensional printing system, the feed stock comprised of a polymer composition, the polymer composition comprising a polypropylene polymer in an amount greater than about 60% by weight, the polypropylene polymer comprising a polypropylene random copolymer or terpolymer, the polypropylene polymer having a melt flow rate of from about 20 g/10 min to about 200 g/10 min, the polypropylene polymer comprising:
   propylene as a primary monomer and containing at least one comonomer of ethylene or butene;
   a total comonomer content of from about 3% by weight to about 25% by weight;
   an ethylene content of from 0% to about 10% by weight;
   a butene content of from 0% to about 20% by weight; and a xylene soluble content of from about 4.5% to about 45% by weight.
B. The polymer material of Paragraph A, wherein the feed stock comprises a filament, the filament having a filament diameter of from about 0.5 mm to about 5 mm, such as from about 1 mm to about 4 mm.
C. The polymer material of Paragraph A, wherein the feed stock comprises polymer pellets or a polymer rod.
D. The polymer material of any one of Paragraphs A-C, wherein the polypropylene polymer comprises a propylene and ethylene copolymer having an ethylene content of from about 3% by weight to about 10% by weight.
E. The polymer material of any one of Paragraphs A-D, wherein the polypropylene polymer comprises a propylene and ethylene copolymer having an ethylene content of from about 5% by weight to about 9% by weight.
F. The polymer material of any one of Paragraphs A-E, wherein the polypropylene polymer comprises a propylene and butene copolymer having a butene content of from about 5% by weight to about 20% by weight.
G. The polymer material of any one of Paragraphs A-F, wherein the polypropylene polymer comprises a propylene, ethylene, and butene terpolymer.
H. The polymer material of any one of Paragraphs A-G, wherein the polypropylene polymer has a xylene content of from about 5% to about 40% by weight, such as from about 10% to about 30% by weight.
I. The polymer material of any one of Paragraphs A-H, wherein the polypropylene polymer has a crystallinity of less than about 50%, such as less than about 40%.
J. The polymer material of any one of Paragraphs A-I, wherein the polypropylene polymer has a molecular weight distribution (Mw/Mn) of from about 2.5 to about 10 such as from about 3 to about 6.
K. The polymer material of any one of Paragraphs A-J, wherein the polymer composition further comprises a filler.
L. The polymer material of Paragraph K, wherein the filler comprises a talc, calcium carbonate, glass fibers, or mixtures thereof.
M. The polymer material of Paragraph K or Paragraph L, wherein the filler is present in the polymer composition in an amount from about 0% by weight to about 40% by weight.
N. The polymer material of any one of Paragraphs A-M, wherein the polypropylene polymer has been Ziegler-Natta catalyzed using a non-phthalate catalyst.
O. The polymer material of any one of Paragraphs A-N, wherein the polypropylene polymer is present in the polymer composition in an amount greater than about 70% by weight, such as in an amount greater than about 80% by weight, such as in an amount greater than about 90% by weight, and generally in an amount less than about 99% by weight, such as in an amount less than about 96% by weight.
P. The polymer material of any one of Paragraphs A-O, wherein the polymer composition further comprises a nucleating agent.
Q. The polymer material of any one of Paragraphs A-P, wherein the polymer composition further comprises a processing aid.
R. A printer cartridge for a three-dimensional extrusion printing system, the printer cartridge containing the polymer material of any one of Paragraphs A-Q.
S. The printer cartridge of Paragraph R, wherein polymer material comprises a filament, the filament being wound around a spool in the printer cartridge.
T. A three-dimensional printing system comprising a three-dimensional printing device and the printer cartridge of Paragraph R or Paragraph S.
U. A three-dimensional article formed from the polymer material of any one of Paragraphs A-Q.
V. The three-dimensional article of Paragraph U, wherein the article was formed layer by layer from the polymer material.
W. A method for producing a three-dimensional article comprising selectively forming a three-dimensional structure from the polymer material of any one of Paragraphs A-Q.

Other embodiments are set forth in the following claims, along with the full scope of equivalents to which such claims are entitled.

1. A polymer material for a three-dimensional extrusion printing system, the polymer material comprising a feed stock having a size and shape suitable for feeding to a three-dimensional printing system, the feed stock comprised of a polymer composition, the polymer composition comprising a polypropylene polymer in an amount greater than about 60% by weight, the polypropylene polymer comprising a polypropylene random copolymer or terpolymer, the polypropylene polymer having a melt flow rate of from about 20 g/10 min to about 200 g/10 min, the polypropylene polymer comprising:
propylene as a primary monomer and containing at least one comonomer of ethylene or butene;
a total comonomer content of from about 3% by weight to about 25% by weight;
an ethylene content of from 0% to about 10% by weight;
a butene content of from 0% to about 20% by weight; and
a xylene soluble content of from about 4.5% to about 45% by weight.

2. The polymer material of claim 1, wherein the feed stock comprises a filament, the filament having a filament diameter of from about 0.5 mm to about 5 mm.

3. The polymer material of claim 1, wherein the feed stock comprises polymer pellets or a polymer rod.

4. The polymer material of claim 1, wherein the polypropylene polymer comprises a propylene and ethylene copolymer having an ethylene content of from about 3% by weight to about 10% by weight.

5. The polymer material of claim 1, wherein the polypropylene polymer comprises a propylene and ethylene copolymer having an ethylene content of from about 5% by weight to about 9% by weight.

6. The polymer material of claim 1, wherein the polypropylene polymer comprises a propylene and butene copolymer having a butene content of from about 5% by weight to about 20% by weight.

7. The polymer material of claim 1, wherein the polypropylene polymer comprises a propylene, ethylene, and butene terpolymer.

8. The polymer material of claim 1, wherein the polypropylene polymer has a xylene content of from about 5% to about 40% by weight.

9. The polymer material of claim 1, wherein the polypropylene polymer has a crystallinity of less than about 50%.

10. The polymer material of claim 1, wherein the polypropylene polymer has a molecular weight distribution (Mw/Mn) of from about 2.5 to about 10.

11. The polymer material of claim 1, wherein the polymer composition further comprises a filler.

12. The polymer material of claim 11, wherein the filler comprises a talc, calcium carbonate, glass fibers, or mixtures thereof.

13. The polymer material of claim 11, wherein the filler is present in the polymer composition in an amount from about 0% by weight to about 40% by weight.

14. The polymer material of claim 1, wherein the polypropylene polymer has been Ziegler-Natta catalyzed using a non-phthalate catalyst.

15. The polymer material of claim 1, wherein the polypropylene polymer is present in the polymer composition in an amount greater than about 70% by weight.

16. The polymer material of claim 1, wherein the polymer composition further comprises a nucleating agent, a processing aid, or both a nucleating agent and a processing aid.

17. (canceled)

18. A printer cartridge for a three-dimensional extrusion printing system, the printer cartridge containing the polymer material of claim 1.

19. The printer cartridge of claim 18, wherein the feed stock comprises a filament, the filament being wound around a spool in the printer cartridge.

20. A three-dimensional printing system comprising a three-dimensional printing device and the printer cartridge of claim 18.

21. A three-dimensional article formed from the polymer material of claim 1.

22-23. (canceled)
